(19) United States
(12) Patent Application Publication
(10) Pub. No.: US 2026/0121208 A1
(43) Pub. Date: Apr. 30, 2026

(54) GAS DISCHARGE DEVICE FOR SECONDARY BATTERY AND GAS DISCHARGE METHOD FOR SECONDARY BATTERY

(71) Applicant: SK On Co., Ltd., Seoul (KR)

(72) Inventors: Joo Yeong KIM, Daejeon (KR); Byeong Chan KIM, Daejeon (KR); Joo Hyung KIM, Daejeon (KR); Gil Yong CHOI, Daejeon (KR); Myung Jun CHOI, Daejeon (KR); Kyung Tae PARK, Daejeon (KR)

(21) Appl. No.: 19/375,208

(22) Filed: Oct. 31, 2025

(30) Foreign Application Priority Data
Oct. 31, 2024 (KR) 10-2024-0152658

(51) Int. Cl. H01M 50/317; H01M 10/04

(52) U.S. Cl. CPC H01M 50/317; H01M 10/0404

(57) ABSTRACT

The present disclosure relates to a gas discharge device and a gas discharge method for a secondary battery. The gas discharge device and the gas discharge method comprise a receiving member having a receiving space, a gripping member configured to hold a pouch cell including a cell portion for accommodating an electrode assembly, a gas portion for accommodating gas discharged from the cell portion, and a connection portion communicating the cell portion with the gas portion, a perforating member installed in the receiving member and configured to form at least one hole in the gas portion, a sealing member installed in the receiving member and configured to heat a predetermined portion of the connection portion to seal the cell portion, a pressing member installed in the receiving member and configured to press at least a part of the connection portion, and a moving member configured to move the gripping member.

### CROSS-REFERENCE TO RELATED PATENT APPLICATION

The present application claims priority under 35 U.S.C. § 119(a) to Korean patent application number 10-2024-0152658 filed on Oct. 31, 2024, in the Korean Intellectual Property Office, the entire disclosure of which is incorporated by reference herein.

### BACKGROUND OF THE INVENTION

### 1. Field

The present disclosure relates to a gas discharge device for a secondary battery and a gas discharge method for a secondary battery, and more particularly, to a device and a method for discharging gas from a pouch cell in which a gas chamber is connected.

### 2. Description of the Related Art

A battery is also referred to as a secondary battery, and among secondary batteries, there is a pouch-type secondary battery. The pouch-type secondary battery has high energy density per unit weight and volume, and is widely used because it facilitates thinning and lightening of the battery cell.

Such a secondary battery can be manufactured by accommodating an electrode assembly inside a pouch, and when a charge-discharge process is performed to activate the manufactured secondary battery, gas is generated inside the pouch.

Accordingly, a gas discharge device is used to remove the gas generated inside the pouch. The conventional gas discharge device is configured to create a vacuum around the pouch while holding the pouch accommodating the cell, and to discharge gas from the inside of the pouch into a gas chamber connected to the pouch.

Furthermore, the conventional gas discharge device seals the pouch by heat-fusing a connection portion connecting the gas chamber and the pouch, and then performs a venting step in which fluid is introduced around the pouch to increase pressure around the pouch.

At this time, during the venting step, a gas chamber that is not held by the gas discharge device is bent due to movements such as contraction in response to the change in surrounding pressure, and the bending of the gas chamber causes the connection portion connecting the gas chamber and the pouch to be creased.

When the connection portion is creased in this manner, cracks may occur in the organic material inside the fused pouch, and through the cracks, the electrolyte may penetrate into the inside of the pouch, so that electrical insulation between the inside and outside of the pouch is not ensured, which may result in a decrease in yield.

Meanwhile, due to a restriction in which the venting step is performed slowly to prevent bending of the gas chamber, it becomes difficult to improve the production efficiency of the secondary battery per unit time.

Accordingly, there is a need to develop a gas discharge device and a gas discharge method that can improve the production efficiency of the secondary battery per unit time, prevent the lack of insulation between the inside and outside of the pouch due to physical external forces, and improve process yield.

### SUMMARY OF THE INVENTION

An object of the present disclosure is to provide a gas discharge device and a gas discharge method for a secondary battery, capable of preventing a decrease in manufacturing process yield of the secondary battery by preventing a lack of insulation between the inside and outside of the pouch due to external forces.

Another object of the present disclosure is to provide a gas discharge device and a gas discharge method for a secondary battery, capable of performing the venting step at a relatively high speed by preventing bending of the gas chamber due to external forces, thereby improving the production amount of the secondary battery per unit time.

Another object of the present disclosure is to provide a gas discharge device and a gas discharge method for a secondary battery, capable of preventing the pouch from being opened by external forces, thereby preventing foreign substances from penetrating into the inside of the pouch.

The gas discharge device and the gas discharge method for a secondary battery according to the present disclosure can be widely applied in green technologies using batteries for electric vehicles. In addition, the gas discharge device and the gas discharge method for a secondary battery according to the present disclosure can be used in batteries for environmentally friendly electric vehicles, hybrid vehicles, and the like, which suppress air pollution and greenhouse gas emissions to prevent climate change.

As a technical means for solving the above-described technical problems, a gas discharge device for a secondary battery according to an embodiment of the present disclosure may include a receiving member having a receiving space formed therein, a cell portion configured to accommodate an electrode assembly, a gas portion configured to accommodate gas discharged from the cell portion, and a connecting portion configured to communicate the cell portion and the gas portion, the receiving member being configured to hold a pouch cell including the cell portion, the gas portion, and the connecting portion, a holding member accommodated in the receiving space, a perforating member installed in the receiving member and configured to form at least one hole in the gas portion, a sealing member installed in the receiving member and configured to heat a predetermined portion of the connecting portion to seal the cell portion, a pressing member installed in the receiving member and configured to press at least a part of the connecting portion including the predetermined portion, and a moving member configured to move the holding member, wherein the moving member may be configured to adjust a position of the connecting portion by moving the holding member such that, when the sealing member seals the cell portion, the pressing member can press the connecting portion including the predetermined portion.

In addition, the sealing member and the pressing member may be disposed at positions spaced apart from each other by a predetermined distance in a first direction, and the moving member is configured to move the holding member in the first direction or in a direction opposite to the first direction.

In addition, the pressing member may be configured to press the entire connecting portion.

In addition, the gas discharge device further may include an intake member installed in the receiving member and configured to discharge a fluid accommodated in the receiving space to the outside of the receiving space to reduce a pressure inside the receiving space, and a pressing member installed in the receiving member and configured to press the cell portion such that gas accommodated in the cell portion moves to the gas portion, wherein the pressing member may be configured such that, when the pressure inside the receiving space reaches a predetermined first pressure, a pressure of a predetermined magnitude is periodically applied to the cell portion a predetermined number of times for a predetermined first time.

In addition, the sealing member may be configured such that, after the pressure inside the receiving space reaches a predetermined second pressure and a predetermined second time has elapsed, the predetermined portion is heated for a predetermined third time, wherein the second pressure may be smaller than the first pressure.

In addition, the gas discharge device further may include a venting member installed in the receiving member and configured to introduce a fluid into the receiving space to increase the pressure inside the receiving space, wherein the venting member may introduce the fluid into the receiving space after the sealing member seals the predetermined portion, and the pressing member may press at least a part of the connecting portion including the predetermined portion while the venting member introduces the fluid into the receiving space.

In addition, the receiving member may further include an openable/closable member configured to selectively communicate the receiving space with the outside of the receiving space or to seal the receiving space, wherein, when the openable/closable member may be opened to communicate the receiving space with the outside, the moving member moves the holding member so that the holding member may be accommodated in the receiving space, and when the holding member may be accommodated in the receiving space, the openable/closable member may be closed to seal the receiving space.

In addition, the perforating member, the sealing member, the pressing member, the moving member, and the pressing member may each be configured to be reciprocally movable.

In addition, a plurality of the holding members may be accommodated in the receiving space, and a plurality of the perforating members, the sealing members, the pressing members, the moving members, and the pressing members may be installed in the receiving member.

As a technical means for solving the above-mentioned technical problems, a gas discharge method for a secondary battery according to an embodiment of the present disclosure may comprise: a receiving step of accommodating a holding member, which holds a pouch cell including a cell portion configured to accommodate an electrode assembly, a gas portion configured to receive gas discharged from the cell portion, and a connecting portion connecting the cell portion and the gas portion, in a receiving space formed in a receiving member; a perforating step of forming at least one hole in the gas portion; an intake step of discharging a fluid accommodated in the receiving space to the outside of the receiving space to reduce the pressure inside the receiving space; a sealing step of heating a predetermined portion of the connecting portion to seal the cell portion; a moving step of moving the holding member; a pressing step of pressing at least a portion of the connecting portion, including the predetermined portion, by a pressing member; and a venting step of introducing a fluid into the receiving space to increase the pressure inside the receiving space, wherein, in the moving step, the holding member may be moved to adjust a position of the connecting portion such that, when the cell portion is sealed, the pressing member can press at least a portion of the connecting portion including the predetermined portion.

In addition, the method may further comprise a pressing step between the intake step and the sealing step, in which the cell portion is pressurized such that gas accommodated in the cell portion moves into the gas portion.

In addition, the pressing step may include periodically applying, a predetermined number of times, a pressure having a predetermined magnitude to the cell portion for a predetermined first time when the pressure inside the receiving space reaches a predetermined first pressure due to the intake step.

In addition, the sealing step may include heating the predetermined portion for a predetermined third time after a predetermined second time has elapsed once the pressure inside the receiving space reaches a predetermined second pressure due to the intake step, wherein the predetermined second pressure may be smaller than the predetermined first pressure.

In addition, the receiving step may include opening a closable/openable gate member installed in the receiving member to receive the holding member into the receiving space, and closing the gate member once the holding member has been received in the receiving space.

Specific details of other embodiments for achieving the objects are included in the description of the invention and drawings.

According to the above-described means for solving the technical problems, the gas discharge apparatus and gas discharge method for a secondary battery according to the present disclosure are configured such that a venting process can be performed while pressing and holding the sealed connecting portion. Accordingly, it is possible to prevent the connecting portion from being deformed, which could otherwise cause cracks in the thermally fused portions of the organic material inside the pouch and thereby impair electrical insulation between the interior and exterior of the pouch. This configuration provides the effect that a secondary battery can be manufactured in which the electrode assembly contained within the pouch is effectively electrically insulated from the outside of the pouch.

In addition, since the venting process can be performed while pressing and holding the sealed connecting portion, even when the venting process is carried out at a relatively high speed, the connecting portion is prevented from being damaged. Thus, the venting process can be performed rapidly without deforming the connecting portion, providing the effect of increasing the production rate of secondary batteries per unit time.

### BRIEF DESCRIPTION OF THE DRAWINGS

FIG. 1 is a view illustrating a gas discharge apparatus for a secondary battery according to one embodiment of the present disclosure.

FIG. 2 is a view illustrating a state in which the holding jig is moved by the moving member so that the position of the connecting portion is adjusted.

FIG. 3 is a view illustrating a state in which the connecting portion, the position of which has been adjusted, is pressed and held by the pressing member.

FIG. 4 is a graph illustrating processes applied to the pouch cell in each partitioned section according to changes in the pressure inside the receiving space.

FIG. 5 is a flowchart illustrating a gas discharge method for a secondary battery according to one embodiment of the present disclosure.

### DETAILED DESCRIPTION

Hereinafter, referring to the accompanying drawings, embodiments of the present disclosure are described in detail so that those skilled in the art to which the present disclosure pertains can easily practice them. However, the present disclosure may be implemented in a number of different forms and is not limited to the embodiments described herein. Further, in order to clearly explain the present disclosure in the drawings, parts that are not related to the explanation are omitted, and similar parts are given similar reference numerals throughout the specification.

Throughout the specification, when it is mentioned that a part is “connected” to another part, it includes not only the case where they are “directly connected,” but also the case where they are “electrically connected” with another element in between.

Throughout the specification, when it is mentioned that an element is “on” another element, this includes not only the case where the element is in contact with the other element, but also the case where there is another element between the two elements.

Throughout the specification, when it is mentioned that a part “includes” or “comprises” a component, this does not mean that it excludes other components, but rather that it may include other components, unless otherwise specifically stated. The terms such as “about” and “substantially”, which indicate degrees, as used throughout the specification, are used in a meaning that is at or near a numerical value when manufacturing and material tolerances inherent in the meanings stated are given, and are used to prevent unscrupulous infringers from unfairly exploiting the disclosure, which states precise or absolute numbers to aid understanding of the present disclosure. The terms “step of doing ˜” or “step of ˜” as used throughout the specification do not mean “step for ˜”.

Hereinafter, with reference to the accompanying drawings and the description below, preferred embodiments of the present disclosure are described in detail. However, the present disclosure is not limited to the embodiments described here, but may be embodied in other forms. Throughout the specification, the same reference numerals represent the same components.

Hereinafter, a gas discharge apparatus for a secondary battery according to one embodiment of the present disclosure will be described.

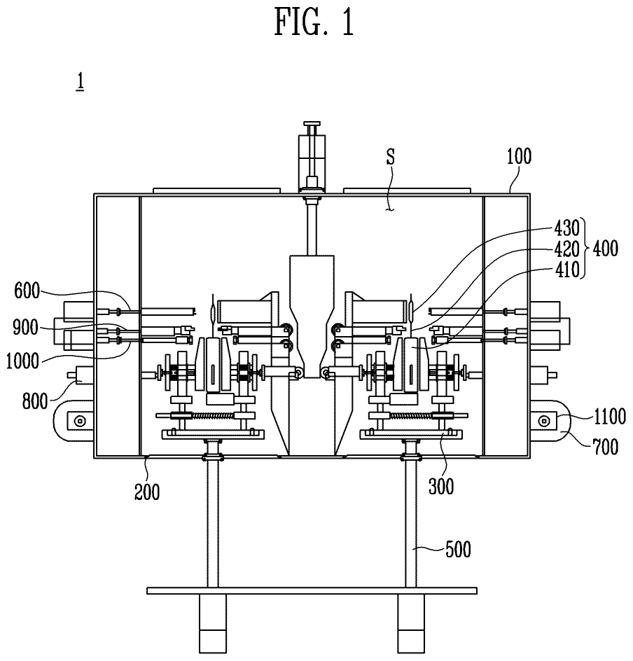

FIG. 1 is a view illustrating a gas discharge apparatus for a secondary battery according to one embodiment of the present disclosure.

Referring to FIG. 1, the battery gas discharge device 1 includes a receiving member 100, an opening and closing member 200, a gripping member 300, a moving member 500, a perforating member 600, an intake member 700, a pressing member 800, a sealing member 900, a compression member 1000, and a venting member.

First, the receiving member 100 will be described.

Referring to FIG. 1, the receiving member 100 may have a receiving space S formed therein, and may be configured such that components of the battery gas discharge device 1 are installed therein.

The receiving member 100 may also be configured to be sealable so that the receiving space S formed inside the receiving member 100 is isolated from the outside of the receiving space S.

Next, the opening and closing member 200 will be described.

Referring to FIG. 1, the opening and closing member 200 is installed in the receiving member 100 and is configured to be openable and closable so as to allow communication between the receiving space S and the outside of the receiving space S or to seal the receiving space S.

When the opening and closing member 200 is opened so that the receiving space S and the outside of the receiving space S are in communication, the moving member 500, which will be described later, can move the gripping member 300, which will be described later, so that the gripping member 300 is accommodated in the receiving space S.

When the gripping member 300 is accommodated in the receiving space S, the opening and closing member 200 can be closed to seal the receiving space S.

The opening and closing member 200 may be installed in at least a portion of the receiving member 100, and preferably, may be installed at a lower portion of the receiving member 100.

Next, the gripping member 300 will be described.

Referring to FIG. 1, the gripping member 300 grips a pouch cell 400, which includes a cell portion 410 that accommodates an electrode assembly, a gas portion 430 that receives gas discharged from the cell portion 410, and a connecting portion 420 that connects the cell portion 410 and the gas portion 430, and can be accommodated in the receiving space S.

Specifically, the gripping member 300 may include a pressing member that presses the cell portion 410 of the pouch cell 400 from both sides to grip the pouch cell 400, while the connecting portion 420 and the gas portion 430 of the pouch cell 400 are not pressed by the gripping member 300 and are arranged in a state connected to the cell portion 410.

For example, as shown in FIG. 1, the connecting portion 420 may be arranged to extend in a direction toward the upper portion of the receiving member 100 while being connected to the cell portion 410, and the gas portion 430 may be arranged to extend in a direction toward the upper portion of the receiving member 100 while being connected to the connecting portion 420.

Meanwhile, the gripping member 300 may be moved by a moving member 500.

For example, the gripping member 300, which is located outside the receiving space S, may be moved into the receiving space S by the moving member 500 when the opening and closing member 200 is opened, and accommodated in the receiving space S.

In another example, the gripping member 300 accommodated inside the receiving space S may be moved by the moving member 500 so that the position of the connecting portion 420 of the pouch cell 400 gripped by the gripping member 300 can be adjusted.

Next, the moving member 500 will be described.

The moving member 500 is configured to move the gripping member 300.

Specifically, as shown in FIG. 1, the moving member 500 is connected to at least a part of the gripping member 300, so that the gripping member 300 located outside the receiving space S can be moved into the receiving space S.

For example, the moving member 500 may include a cylinder to move a predetermined object connected to the moving member 500, and when the opening and closing member 200 is opened, the gripping member 300 located outside the receiving space S may be moved into the receiving member 100 through the opened opening and closing member 200.

In addition, the moving member 500 may move the gripping member 300 so that the position of the connecting portion 420 of the pouch cell 400 gripped by the gripping member 300 can be adjusted.

That is, the moving member 500 may move the gripping member 300 to adjust the position of the connecting portion 420, so that when the sealing member 900 seals the cell portion 410, the pressing member 1000 can apply pressure to at least a part of the connecting portion 420 including a predetermined portion of the connecting portion 420.

Next, the punching member 600 will be described.

As shown in FIG. 1, the punching member 600 is installed in the receiving member 100 and can form at least one hole in the gas portion 430.

Specifically, the punching member 600 may be configured to move toward the gas portion 430 of the pouch cell 400 gripped by the gripping member 300 accommodated in the receiving space S, so that a hole can be formed in the gas portion 430.

For example, the punching member 600 may include a cylinder to allow reciprocal movement, and a punching member capable of forming a hole in a predetermined object may be installed on one side, such that the punching member moves toward the gas portion 430 to form a hole in the gas portion 430.

Next, the intake member 700 will be described.

As shown in FIG. 1, the intake member 700 is installed in the receiving member 100 and may be configured to discharge a fluid accommodated in the receiving space S to the outside of the receiving space S, thereby reducing the pressure inside the receiving space S.

For example, the intake member 700 may include a pump configured to suction a predetermined fluid, and may be formed so that the fluid, including a gas accommodated in a predetermined space, is suctioned and discharged to the outside of the predetermined space, thereby reducing the pressure inside the receiving space S.

Next, the pressing member 800 will be described.

As shown in FIG. 1, the pressing member 800 is installed in the receiving member 100 and may perform a function of pressing the cell portion 410 so that gas accommodated inside the cell portion 410 moves toward the gas portion 430.

For example, the pressing member 800 may include a cylinder configured to reciprocate, and a contact member may be provided on one side to contact a predetermined object. The contact member may be configured to move toward the pressing member of the holding member 300 that presses the cell portion 410, so that the pressing member can be pressed.

The pressing member 800 may move toward the pressing member and press the pressing member to press the cell portion 410 when the pressure inside the receiving space S is reduced by the intake member 700.

For example, when the pressure inside the receiving space S reaches a predetermined first pressure, the pressing member 800 may periodically apply a pressure of a predetermined magnitude to the cell portion 410 for a predetermined first time for a predetermined number of cycles.

Next, the sealing member 900 will be described.

As shown in FIG. 1, the sealing member 900 is installed in the receiving member 100 and may be configured to heat a predetermined portion of the connecting portion 420 to seal the cell portion 410.

Specifically, the sealing member 900 may be configured to move toward the connecting portion 420 of the pouch cell 400 held by the holding member 300 accommodated in the receiving space S, so that heat is applied to the connecting portion 420. In this case, the sealing member 900 may be configured to apply heat to the connecting portion 420 while pressing the connecting portion 420.

For example, the sealing member 900 may include a cylinder configured to reciprocate, and a heating member may be provided on one side. The heating member may be configured to move toward the connecting portion 420 to heat a predetermined portion of the connecting portion 420.

Thus, when the predetermined portion of the connecting portion 420 is heated by the sealing member 900, the connecting portion 420 that communicates the cell portion 410 and the gas portion 430 is thermally fused, so that the cell portion 410 can be sealed.

Meanwhile, when the pressure inside the receiving space S is reduced by the intake member 700, the sealing member 900 may move toward the connecting portion 420 and heat the connecting portion 420 to seal the cell portion 410.

For example, after the pressure inside the receiving space S reaches a predetermined second pressure due to the intake member 700 and a predetermined second time has elapsed, the sealing member 900 may heat a predetermined portion of the connecting portion 420 for a predetermined third time.

In this case, the second pressure may be lower than the first pressure.

Next, the pressing member 1000 will be described.

Referring to FIG. 1, the pressing member 1000 is installed in the receiving member 100 and may be configured to press at least a portion of the connecting portion 420 including a predetermined part of the connecting portion 420. In this case, the pressing member 1000 may be configured to press at least a portion of the connecting portion 420 to hold it.

Specifically, when a predetermined portion of the connecting portion 420 is heated by the sealing member 900 and the cell portion 410 is sealed, the moving member 500 may move the holding member 300 to adjust the position of the connecting portion 420, and the pressing member 1000 may move toward the position-adjusted connecting portion 420 to press the connecting portion 420.

For example, the pressing member 1000 may include a cylinder configured to move reciprocally, and a pressing member capable of pressing a predetermined object may be provided at one side. The pressing member may be moved toward the connecting portion 420 to press at least a portion of the connecting portion 420 including the predetermined portion.

In this case, the pressing member 1000 may be configured as a pair arranged to face each other across the connecting portion 420, so that one side and the other side of the connecting portion 420 are pressed simultaneously.

Meanwhile, the sealing member 900 and the pressing member 1000 may be arranged at positions spaced a predetermined distance along a first direction, and the moving member 500 may move the holding member 300 in the first direction or in the opposite direction of the first direction.

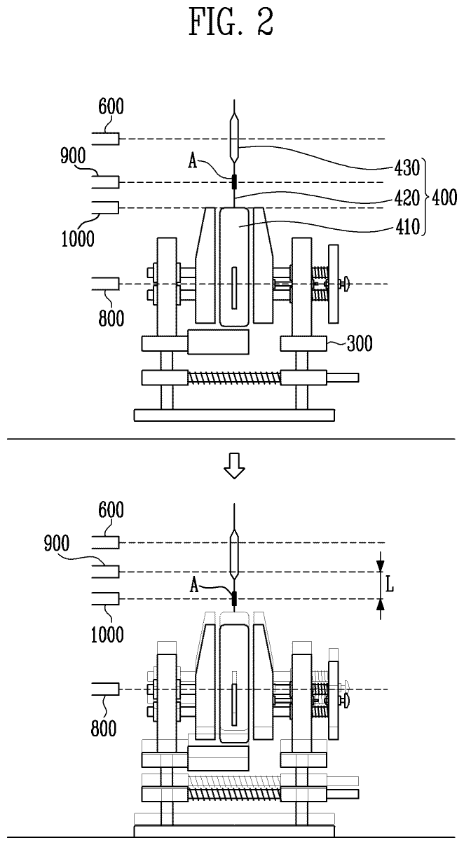

FIG. 2 is a view illustrating a state in which the holding jig is moved by the moving member so that the position of the connecting portion is adjusted.

As shown in FIG. 2, the sealing member 900 may be disposed at a position spaced a predetermined distance from the pressing member 1000 along a first direction.

In this case, the connecting portion 420 may be positioned on the moving path of the sealing member 900, and the sealing member 900 may move toward the connecting portion 420 to heat a predetermined portion A of the connecting portion 420, thereby sealing the cell portion 410.

When the predetermined portion A of the connecting portion 420 is heated by the sealing member 900, as shown in FIG. 2, the moving member 500 may move the holding member 300 in the opposite direction of the first direction so that the predetermined portion A of the connecting portion 420 heated by the sealing member 900 is positioned on the moving path of the pressing member 1000.

Accordingly, the pressing member 1000 may move toward the connecting portion 420 to press the predetermined portion A of the connecting portion 420.

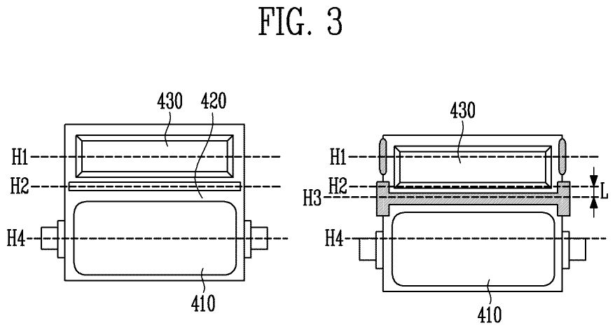

FIG. 3 is a view illustrating a state in which the connecting portion, the position of which has been adjusted, is pressed and held by the pressing member.

Referring to FIG. 3, the gas portion 430 is positioned on the moving path H1 of the punching member 600, the connecting portion 420 is positioned on the moving path H2 of the sealing member 900, and the cell portion 410 is positioned on the moving path H4 of the pressing member 800.

In this case, after the sealing member 900 moves and heats the connecting portion 420, the moving member 500 may move the holding member 300 by a predetermined length L so that the connecting portion 420 is positioned on the moving path H3 of the pressing member 1000.

Next, as shown in FIG. 3, the pressing member 1000 presses at least a portion of the connecting portion 420 including a predetermined portion A of the connecting portion 420. In this case, the pressing member 1000 may be configured to press the entire connecting portion 420.

In this manner, when the pressing member 1000 is configured to press the entire connecting portion 420, the connecting portion 420 can be more effectively prevented from being crumpled due to bending of the gas chamber 430 during the venting process.

Next, the venting member 1100 will be described.

The venting member 1100 is installed in the receiving member 100 and may be configured to introduce a fluid, such as a gas, into the receiving space S to increase the pressure inside the receiving space S. In other words, the venting member 1100 may allow a fluid from outside the receiving space S to flow into the receiving space S.

For example, the venting member 1100 may include a fluid injection device configured to inject a fluid, such as a gas, into a predetermined space. The venting member 1100 may introduce a fluid into the receiving space S after the sealing member 900 has heated a predetermined portion of the connecting portion 420.

At this time, the pressing member 1000 may press at least a portion of the connecting portion 420 including the predetermined portion of the connecting portion 420 while the venting member 1100 introduces the fluid into the receiving space S.

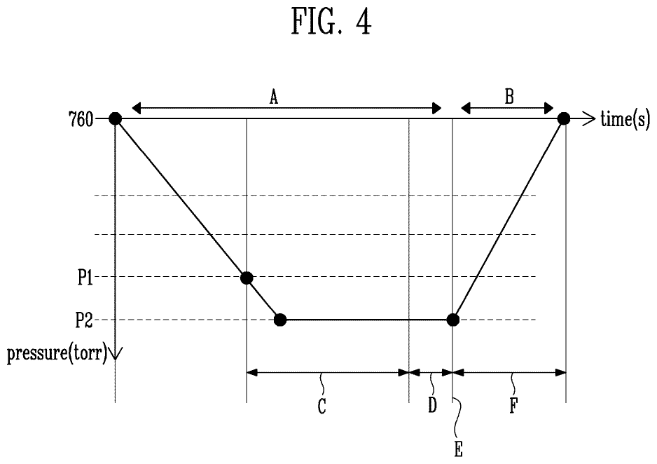

FIG. 4 is a graph illustrating processes applied to the pouch cell in each partitioned section according to changes in the pressure inside the receiving space.

Referring to FIG. 4, in a first section A, the intake member 700 may be operated to discharge the fluid accommodated in the receiving space S to the outside of the receiving space S, and in this first section A, the pressure inside the receiving space S decreases or remains constant over time. In a second section B, in which the venting member introduces a fluid into the receiving space S, the pressure inside the receiving space S increases over time.

Specifically, when the pressure inside the receiving space S reaches a first pressure P1 as a result of the operation of the intake member 700, in a third section C, the pressing member 800 may be operated to press the cell portion 410 and move the gas accommodated inside the cell portion 410 into the gas portion 430.

Then, in a fourth section D, when the pressure inside the receiving space S reaches a second pressure P2 as a result of the operation of the intake member 700, the operation of the pressing member 800 is stopped, and the sealing member 900 is operated to heat a predetermined portion of the connecting portion 420.

Next, in a fifth section F, in which the pressure inside the receiving space S increases due to the operation of the venting member, the operation of the sealing member 900 is stopped, and the gripping member 300 is moved to adjust the position of the connecting portion 420. Then, the pressing member 1000 is operated to press the connecting portion 420.

Meanwhile, as described above, the punching member 600, the sealing member 900, the pressing member 1000, the moving member 500, and the pressing member 800 may each be configured to be reciprocally movable. For example, the punching member 600, the sealing member 900, the pressing member 1000, the moving member 500, and the pressing member 800 may each include a cylinder and be configured to be reciprocally movable, although the configurations of the punching member 600, the sealing member 900, the pressing member 1000, the moving member 500, and the pressing member 800 are not limited thereto.

In addition, a plurality of gripping members 300 may be accommodated in the receiving space S, and a plurality of the punching members 600, sealing members 900, pressing members 1000, moving members 500, and pressing members 800 may be installed in the receiving device 100.

Hereinafter, a method for discharging gas from a secondary battery according to an embodiment of the present disclosure will be described.

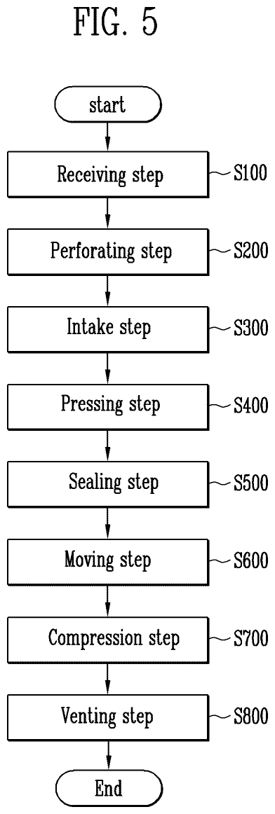

FIG. 5 is a flowchart illustrating a gas discharge method for a secondary battery according to one embodiment of the present disclosure.

Referring to FIG. 5, the method for discharging gas from a secondary battery may include a receiving step S100, a punching step S200, an intake step S300, a pressing step S400, a sealing step S500, a moving step S600, a compression step S700, and a venting step S800.

First, the receiving step S100 will be described.

The receiving step S100 is a step of accommodating a gripping member that holds a pouch cell in a receiving space of a receiving device in which the receiving space S is formed, the pouch cell including a cell portion that accommodates an electrode assembly, a gas portion that receives gas discharged from the cell portion, and a connecting portion that interconnects the cell portion and the gas portion.

Specifically, in the receiving step S100, the receiving device installed with an openable/closable opening member may open the opening member to accommodate the gripping member in the receiving space, and when the gripping member is accommodated in the receiving space, the opening member may be closed.

In this case, the receiving device, the pouch cell, the gripping member, and the opening/closing member may be configured identically to the receiving device 100, the pouch cell 400, the gripping member 300, and the opening/closing member 200 of the gas discharging device 1 for a secondary battery described above.

Next, the punching step S200 will be described.

The punching step S200 is a step of forming at least one hole in the gas portion of the pouch cell.

In the punching step S200, the hole may be formed in the gas portion by using a punching member, and the punching member may be configured identically to the punching member 600 of the gas discharging device 1 for a secondary battery described above.

Next, the suction step S300 will be described.

The suction step S300 is a step of discharging the fluid accommodated in the receiving space to the outside of the receiving space to reduce the pressure inside the receiving space.

In the suction step S300, the fluid, such as gas, accommodated in the receiving space may be discharged to the outside of the receiving space by using a suction member, and the suction member may be configured identically to the suction member 700 of the gas discharging device 1 for a secondary battery described above. Next, the pressing step S400 will be described.

The pressing step S400 is a step of pressurizing the cell portion so that the gas accommodated in the cell portion moves to the gas portion.

Specifically, in the pressing step S400, when the pressure inside the receiving space reaches a predetermined first pressure due to the suction step S300, a pressure having a predetermined magnitude may be applied to the cell portion a predetermined number of times periodically for a predetermined first time.

In the pressing step S400, the cell portion may be pressurized using a pressurizing member, and the pressurizing member may be configured identically to the pressurizing member 800 of the gas discharging device 1 for a secondary battery described above.

Next, the sealing step S500 will be described.

The sealing step S500 is a step of heating a predetermined portion of the connecting portion to seal the cell portion. In this case, the sealing step S500 may heat the predetermined portion of the connecting portion while pressurizing the connecting portion to seal the cell portion.

Specifically, in the sealing step S500, after the pressure inside the receiving space reaches a predetermined second pressure due to the suction step S300 and a predetermined second time has elapsed, a predetermined portion of the connecting portion may be heated for a predetermined third time.

Here, the second pressure may be smaller than the first pressure.

In the sealing step S500, the predetermined portion of the connecting portion may be heated using a sealing member, and the sealing member may be configured identically to the sealing member 900 of the gas discharging device 1 for a secondary battery described above.

Next, the moving step S600 will be described.

The moving step S600 is a step of moving the holding member.

Specifically, in the moving step S600, after the cell portion is sealed, the holding member may be moved to adjust the position of the connecting portion so that the pressing member, described below, can press at least a part of the connecting portion including a predetermined portion. In this case, in the moving step S600, after the cell portion is sealed, the holding member may be moved to adjust the position of the connecting portion so that the pressing member can press at least a part of the connecting portion including the predetermined portion while holding it.

In the moving step S600, the holding member may be moved using a moving member, and the moving member may be configured identically to the moving member 500 of the gas discharging device 1 for a secondary battery described above. Next, the pressing step S700 will be described.

The pressing step S700 is a step of pressing at least a part of the connecting portion, including a predetermined portion, using the pressing member.

In the pressing step S700, the pressing member that presses at least a part of the connecting portion may be configured identically to the pressing member 1000 of the gas discharging device 1 for a secondary battery described above.

Next, the venting step S800 will be described.

The venting step S800 is a step of introducing a fluid into the receiving space to increase the pressure inside the receiving space. In other words, the venting step S800 may introduce a fluid from outside the receiving space into the receiving space to reduce the concentration of gas contained within the receiving space.

Specifically, in the venting step S800, a venting member may be used to introduce a fluid into the receiving space, and the venting member may be configured identically to the venting member of the gas discharging device 1 for a secondary battery described above.

As described above, the gas discharging device for a secondary battery and the gas discharging method for a secondary battery according to the present disclosure are configured such that the venting step can be performed while the sealed connection portion is pressed and held. Therefore, it is possible to prevent the connection portion from being crushed and causing cracks in the thermally fused portion of the internal organic material of the pouch, which would otherwise result in the internal and external portions of the pouch not being electrically insulated. Accordingly, a secondary battery in which the electrode assembly contained inside the pouch is effectively insulated from the exterior of the pouch can be manufactured.

In addition, since the venting step can be performed while the sealed connection portion is pressed and held, even when the venting step is carried out at a relatively high speed, damage to the connection portion can be prevented. Therefore, the venting step can be performed rapidly without crushing the connection portion, thereby improving the production rate of the secondary battery per unit time.

The above description of the present disclosure is for illustrative purposes only, and a person skilled in the art to which the present disclosure pertains will understand that the present disclosure may be easily modified into other specific forms without changing the technical idea or essential features of the present disclosure. Therefore, it should be understood that the embodiments described above are exemplary in all respects and not limiting. For example, each component described as a single entity may be implemented in a distributed manner, and likewise, components described as distributed may be implemented in a combined manner.

The scope of the present disclosure is indicated by the appended claims rather than the detailed description above, and all changes or modifications derived from the meaning and scope of the claims and their equivalent concepts should be construed as being included in the scope of the present disclosure.

What is claimed is:

1. A gas discharge device for a secondary battery, comprising:
a receiving member having a receiving space formed therein;
a gripping member configured to grip a pouch cell, the pouch cell comprising a cell portion configured to receive an electrode assembly, a gas portion configured to receive gas discharged from the cell portion, and a connecting portion configured to communicate the cell portion and the gas portion, the gripping member being configured to accommodate the pouch cell in the receiving space;
a perforating member installed on the receiving member and configured to form at least one hole in the gas portion;
a sealing member installed on the receiving member and configured to heat a predetermined portion of the connecting portion to seal the cell portion;
a pressing member installed on the receiving member and configured to press at least a part of the connecting portion including the predetermined portion; and
a moving member configured to move the gripping member,
wherein the moving member is configured to move the gripping member to adjust a position of the connecting portion such that the pressing member can press the connecting portion including the predetermined portion when the sealing member seals the cell portion.

2. The gas discharge device for a secondary battery according to claim 1, wherein the sealing member and the pressing member are disposed at positions spaced apart by a predetermined distance along the first direction, and
wherein the moving member is configured to move the gripping member in the first direction or in a direction opposite to the first direction.

3. The gas discharge device for a secondary battery according to claim 2, wherein the pressing member is configured to press the entire connecting portion.

4. The gas discharge device for a secondary battery according to claim 2, further comprising:
an intake member installed on the receiving member and configured to discharge a fluid accommodated in the receiving space to outside the receiving space, thereby reducing a pressure inside the receiving space; and
a pressing member installed on the receiving member and configured to press the cell portion so that gas accommodated in the cell portion moves to the gas portion,
wherein the pressing member is configured to periodically apply a pressure of a predetermined magnitude to the cell portion a predetermined number of times for a predetermined first time when a pressure inside the receiving space reaches a predetermined first pressure.

5. The gas discharge device for a secondary battery according to claim 4, wherein the sealing member heats the predetermined portion for a predetermined third time after a predetermined second time has elapsed once a pressure inside the receiving space reaches a predetermined second pressure, and
wherein the predetermined second pressure is smaller than the predetermined first pressure.

6. The gas discharge device for a secondary battery according to claim 5, further comprising a venting member installed on the receiving member and configured to introduce a fluid into the receiving space to increase a pressure inside the receiving space,
wherein the venting member introduces the fluid into the receiving space after the sealing member seals the predetermined portion, and
wherein the pressing member presses at least a part of the connecting portion including the predetermined portion while the venting member introduces the fluid into the receiving space.

7. The gas discharge device for a secondary battery according to claim 6, further comprising an open/close member installed on the receiving member and configured to be openable and closable to communicate the receiving space with the outside of the receiving space or to seal the receiving space,
wherein, when the open/close member is opened to communicate the receiving space with the outside of the receiving space, the moving member moves the gripping member to be accommodated in the receiving space, and
wherein, when the gripping member is accommodated in the receiving space, the open/close member is closed to seal the receiving space.

8. The gas discharge device for a secondary battery according to claim 7, wherein the perforating member, the sealing member, the pressing member, the moving member, and the pressing member are configured to be reciprocally movable.

9. The gas discharge device for a secondary battery according to claim 7, wherein a plurality of the gripping members can be accommodated in the receiving space, and
wherein a plurality of the perforating members, the sealing members, the pressing members, the moving members, and the pressing members are installed on the receiving member.

10. A gas discharge method for a secondary battery, comprising:
a receiving step of accommodating, in a receiving space of a receiving member having a receiving space formed therein, a gripping member configured to grip a pouch cell comprising a cell portion configured to receive an electrode assembly, a gas portion configured to receive gas discharged from the cell portion, and a connecting portion configured to communicate the cell portion and the gas portion;
a perforating step of forming at least one hole in the gas portion;
an intake step of discharging a fluid accommodated in the receiving space to outside the receiving space, thereby reducing a pressure inside the receiving space;
a sealing step of heating a predetermined portion of the connecting portion to seal the cell portion;
a moving step of moving the gripping member;
a pressing step of pressing at least a part of the connecting portion including the predetermined portion by a pressing member; and
a venting step of introducing a fluid into the receiving space to increase a pressure inside the receiving space,
wherein, in the moving step, the gripping member is moved to adjust a position of the connecting portion such that the pressing member can press at least a part of the connecting portion including the predetermined portion when the cell portion is sealed.

11. The gas discharge method for a secondary battery according to claim 10, further comprising, between the intake step and the sealing step, a pressing step of pressing the cell portion so that gas accommodated in the cell portion moves to the gas portion.

12. The gas discharge method for a secondary battery according to claim 11, wherein the pressing step periodically applies, a predetermined number of times during a predetermined first time, a pressure having a predetermined magnitude to the cell portion when a pressure inside the receiving space reaches a predetermined first pressure due to the intake step.

13. The gas discharge method for a secondary battery according to claim 12, wherein the sealing step heats the predetermined portion for a predetermined third time after a predetermined second time has elapsed when a pressure inside the receiving space reaches a predetermined second pressure due to the intake step, and
wherein the predetermined second pressure is smaller than the predetermined first pressure.

14. The gas discharge method for a secondary battery according to claim 13, wherein the receiving step comprises opening an openable/closable opening member installed in the receiving member to accommodate the gripping member in the receiving space, and closing the opening member when the gripping member is accommodated in the receiving space.
